(19) United States
(12) Patent Application Publication
(10) Pub. No.: US 2024/0097163 A1
(43) Pub. Date: Mar. 21, 2024

(54) FUEL CELL VEHICLE

(71) Applicant: ISUZU MOTORS LIMITED, Yokohama-shi (JP)

(72) Inventor: Kenichiro TSUDA, Fujisawa-shi (JP)

(21) Appl. No.: 18/244,876

(22) Filed: Sep. 11, 2023

(30) Foreign Application Priority Data
Sep. 16, 2022 (JP) 2022-148043

(51) Int. Cl. H01M 8/04746; B60L 50/75; B60L 58/40; H01M 8/04082; H01M 8/0438; H01M 8/04537; H01M 8/04858

(52) U.S. Cl. CPC H01M 8/04753; B60L 50/75; B60L 58/40; H01M 8/04201; H01M 8/04425; H01M 8/04626; H01M 8/04947; H01M 2250/20

(57) ABSTRACT

To provide a fuel cell vehicle that can improve fuel consumption in a cost-effective manner. A fuel cell vehicle of the present disclosure includes: a fuel cell; an air tank configured to store compressed air; and a control section configured to make a selection for selecting which of outside air and the compressed air in the air tank is to be supplied to the fuel cell on a basis of a first pressure, the first pressure being a pressure of the compressed air in the air tank.

### CROSS REFERENCE TO RELATED APPLICATIONS

This application is entitled to and claims the benefit of Japanese Patent Application No. 2022-148043, filed on Sep. 16, 2022, the disclosure of which including in this specification, drawings and abstract is incorporated herein by reference in its entirety.

### TECHNICAL FIELD

The present disclosure relates to a fuel cell vehicle that runs by using the power generated by a fuel cell.

### BACKGROUND ART

Fuel cell vehicles are being developed that generate electricity by causing a reaction between oxygen in the atmosphere and fuel gas (e.g., hydrogen) and use the generated power to generate driving force. In the case where large vehicles such as trucks are configured as fuel cell vehicles, it is necessary to draw a larger output from the fuel cell unit compared to passenger cars.

However, the higher the output of the fuel cell unit, the more hydrogen is consumed. In view of this, it is desirable to improve the fuel consumption.

Japanese Patent Application Laid-Open No. 2014-241215 discloses a technique in which when there is a surplus of the power generated by a fuel cell, the generated power is used to operate the compressor so as to supply compressed air to the air tank. In such a technique, the surplus power is converted to the air pressure of the air tank and effectively used for opening/closing the door and the brake to achieve improvement in the fuel consumption.

### SUMMARY OF INVENTION

### Technical Problem

However, in the technique disclosed in Japanese Patent Application Laid-Open No. 2014-241215, the surplus of the power generated by a fuel cell is generated, and as such it is necessary to ensure a larger performance of the power generation of the fuel cell. Consequently, the manufacturing cost of the vehicle increases.

An object of the present disclosure is to provide a fuel cell vehicle that can improve the fuel consumption in a cost-effective manner.

### Solution to Problem

A fuel cell vehicle according to an aspect of the present disclosure includes: a fuel cell; an air tank configured to store compressed air; and a control section configured to make a selection for selecting which of outside air and the compressed air in the air tank is to be supplied to the fuel cell on a basis of a first pressure, the first pressure being a pressure of the compressed air in the air tank.

### Advantageous Effects of Invention

According to the present disclosure, the fuel consumption can be improved in a cost-effective manner.

### BRIEF DESCRIPTION OF DRAWINGS

FIG. 1 is a diagram schematically illustrating a configuration of a fuel cell vehicle according to an embodiment of the present disclosure;

FIG. 2 is a flowchart for describing a selection control of an air supply source to a fuel cell by a control section;

FIG. 3 is a diagram for describing an air supply path when a selection is made to supply compressed air in an air tank to the fuel cell;

FIG. 4 is a diagram for describing an air supply path when outside air is compressed by a compressor and supplied to the fuel cell and the air tank;

FIG. 5 is a diagram for describing an air supply path when compressed air in the air tank is supplied to the fuel cell through a compressor; and

FIG. 6 is a flowchart for describing a selection control of a supply destination of regenerated power by the control section.

### DESCRIPTION OF EMBODIMENTS

Each embodiment of the present disclosure is elaborated below with reference to the accompanying drawings. It should be noted that, detailed description of well-known matters, overlapping description of substantially the same components and the like may be omitted.

### Configuration of Vehicle

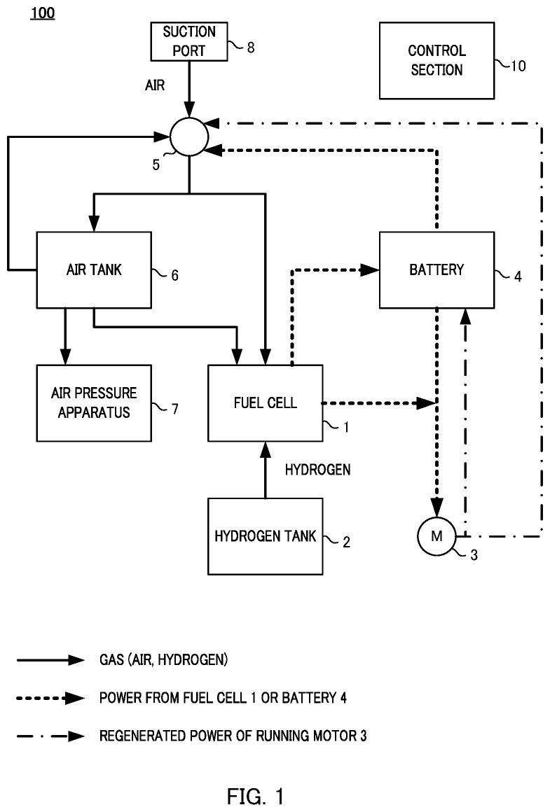

FIG. 1 is a diagram schematically illustrating a configuration of fuel cell vehicle 100 according to an embodiment of the present disclosure. It is assumed that fuel cell vehicle 100 is a large vehicle such as a truck, for example.

As illustrated in FIG. 1, fuel cell vehicle 100 includes fuel cell 1, hydrogen tank 2, running motor 3, battery 4 serving as secondary battery, compressor 5, air tank 6, air pressure apparatus 7, and suction port 8. In addition, fuel cell vehicle 100 further includes control section 10 for controlling each configuration. In FIG. 1, the solid line arrow indicates a flow of gas (air, or hydrogen). The broken line arrow indicates a flow of power supplied from fuel cell 1 or battery 4. The dashed line arrow indicates a flow of power generated by regeneration of running motor 3.

Fuel cell 1 is a battery that generates power through a reaction between the hydrogen stored in hydrogen tank 2 and the air (outside air) taken from suction port 8. While various types of fuel cell 1 that causes a reaction between air and hydrogen are known, fuel cell 1 in the present disclosure may be of any type. In addition, the fuel gas for a reaction with air is not limited to hydrogen, and any fuel gas may be used.

Running motor 3 is a motor that drives the wheels of fuel cell vehicle 100 with the power generated by fuel cell 1. In addition, running motor 3 may drive the wheels with the power charged in battery 4. Running motor 3 is connected to fuel cell 1 or battery 4 through the inverter. Which power is used for driving the wheels by running motor 3 is controlled by control section 10.

In addition, running motor 3 generates power with the rotational force of the wheel as an input at the time of braking of fuel cell vehicle 100 and the like. In this specification, the power generation by running motor 3 at the time of braking and the like is referred to as regenerative power generation, and the power generated by the regenerative power generation is referred to as regenerated power. The regenerated power may be charged to battery 4, or consumed by an electricity-operated configuration provided in fuel cell vehicle 100. Examples of the electricity-operated configuration include compressor 5, an auxiliary machine such as a hydrogen pump (a configuration of supplying the hydrogen of hydrogen tank 2 to fuel cell 1), and an accessory such as an air-conditioner and a radio. In the following description, the electricity-operated configuration of fuel cell vehicle 100 is referred to as electric equipment.

Battery 4 is an example of a secondary battery of the present disclosure. Battery 4 stores at least a part of the power generated by fuel cell 1, and the power regenerated by running motor 3, and supplies the power to the electric equipment of fuel cell vehicle 100 as necessary. Batteries of many types are generally known, but the type of battery 4 mounted in fuel cell vehicle 100 of the present disclosure is not limited.

Compressor 5 is a compressor that compresses air. A pipe extended from the outlet side of air tank 6 and suction port 8 is connected to the inlet side of compressor 5. Compressor 5 compresses the outside air taken from suction port 8, or compressor 5 takes the compressed air in air tank 6 and further compresses the compressed air. A pipe extended toward the inlet side of fuel cell 1 and air tank 6 is connected to the outlet side of compressor 5. The air compressed by compressor 5 is supplied to air tank 6 or fuel cell 1 under the control of control section 10.

Air tank 6 is a tank that stores compressed air. The compressed air stored in air tank 6 is mainly used in air pressure apparatus 7. Air pressure apparatus 7 is an apparatus that performs work with the air pressure force. Examples of air pressure apparatus 7 include a transmission, a brake, a suspension and the like.

In addition, when the pressure of the compressed air stored in air tank 6 is sufficiently high, the compressed air stored in air tank 6 is supplied to fuel cell 1 under the control of control section 10. In this case, the air that is already compressed is supplied from air tank 6 to fuel cell 1, and therefore it is not necessary to compress the outside air by compressor 5 in some cases. Details of the control of control section 10 are described later.

Suction port 8 takes the outside air into fuel cell vehicle 100. Suction port 8 is connected to fuel cell 1 and air tank 6 through compressor 5.

Control section 10 generally controls each configuration of fuel cell vehicle 100. The control of control section 10 is elaborated below.

### (1) Control of Source of Air Supply to Fuel Cell 1

Control section 10 selectively determines the supply source that supplies compressed air to fuel cell 1 in accordance with the status of fuel cell vehicle 100. This control is described below.

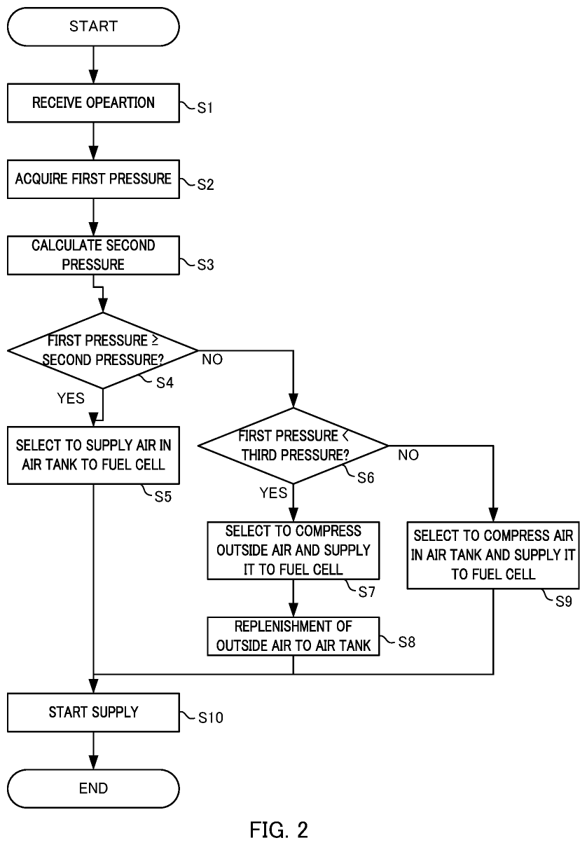

FIG. 2 is a flowchart for describing a selection control of the source of air supply to fuel cell 1 by control section 10.

At step S1, control section 10 receives a driver's operation of requesting an operation requiring power generation of fuel cell 1. The operation requiring power generation of fuel cell 1 is running of fuel cell vehicle 100, for example. More specifically, when the driver depresses the accelerator pedal, control section 10 supplies hydrogen and air to fuel cell 1 to generate the power for running motor 3 to generate the driving force corresponding to the depressing amount. Alternatively, when the driver operates another electric equipment, e.g., an activation switch of an accessory, control section 10 may supply hydrogen and air to fuel cell 1 in accordance with the power consumption of the electric equipment to be operated.

At step S2, control section 10 acquires the pressure of compressed air in the air tank. In the following description, the pressure of compressed air in the air tank is referred to as first pressure. Data related to the first pressure is obtained from a pressure sensor provided in the air tank and the like, for example.

At step S3, control section 10 calculates a second pressure, which is the pressure of the compressed air required for fuel cell 1 to generate the power required for achieving the operation of step S1. Control section 10 may determine the second pressure in the following manner, for example. First, control section 10 calculates the power generation amount (required power [kW]) that should be generated by fuel cell 1 to achieve the operation of step S1. Then, a flow rate per time (required air flow rate [L/s]) of the compressed air required for fuel cell 1 is calculated based on the required power. Then, the second pressure is calculated based on the required air flow rate.

Note that, while the acquisition of the first pressure of step S2 precedes the calculation of the second pressure of step S3 in the example illustrated in FIG. 2, they may be performed in a reversed order or may be simultaneously performed in practice.

At step S4, control section 10 compares the first pressure and the second pressure. When it is determined at step S4 that the first pressure is equal to or greater than the second pressure (step S4: YES), control section 10 advances the process to step S5. When it is determined at step S4 that the first pressure is not equal to or greater than the second pressure (step S4: NO), control section 10 advances the process to step S6.

When the first pressure is equal to or greater than the second pressure, the compressed air in air tank 6 required for fuel cell 1 to generate the required power is considered to meet the required pressure. In view of this, when it is determined at step S4 that the first pressure is equal to or greater than the second pressure, control section 10 makes a selection such that the compressed air in air tank 6 is supplied to fuel cell 1 at step S5.

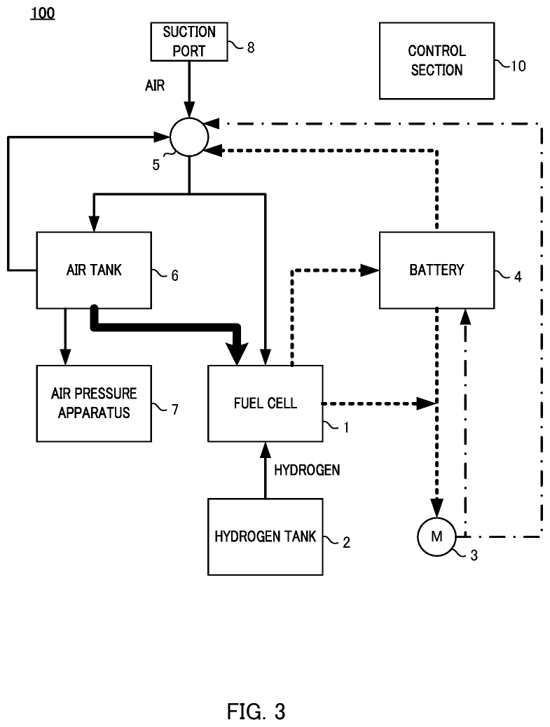

FIG. 3 is a diagram for describing an air supply path when a selection is made such that the compressed air in air tank 6 is supplied to fuel cell 1. The heavy line arrow indicates the supply path.

On the other hand, when the first pressure is smaller than the second pressure, it is considered that the sufficient compressed air for supply to fuel cell 1 is not stored in air tank 6. In this case, at step S6, control section 10 further compares the first pressure and a third pressure, which is a threshold value smaller than the second pressure. When it is determined that the first pressure is smaller than the third pressure at step S6 (step S6: YES), control section 10 advances the process to step S7. When it is determined that the first pressure is not smaller than the third pressure at step S6 (step S6: NO), control section 10 advances the process to step S9.

The third pressure is a minimum necessary pressure of the compressed air in air tank 6 for operating air pressure apparatus 7. That is, when the first pressure is smaller than the third pressure, the required compressed air is insufficient in air tank 6. In this case, at step S7, control section 10 makes a selection to compress the outside air taken from suction port 8 in compressor 5 and supply it to fuel cell 1. Then, at step S8, control section 10 performs an operation for replenishment of the compressed air in air tank 6 by compressing the outside air taken from suction port 8 in compressor 5 and supplying it to air tank 6.

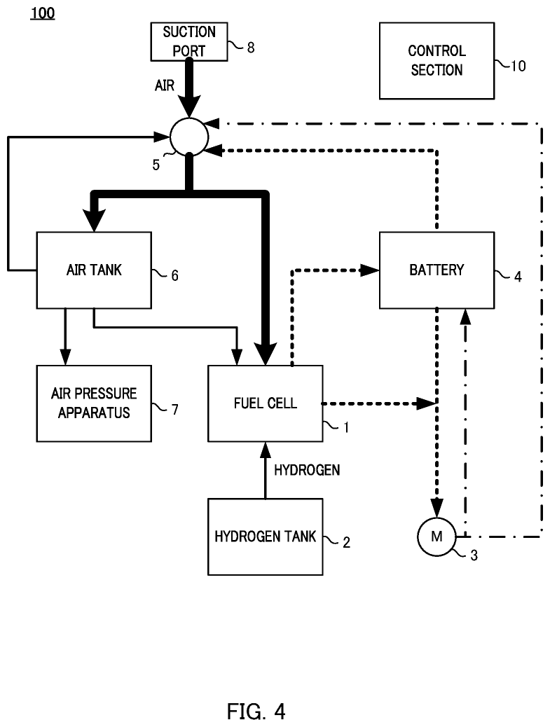

FIG. 4 is a diagram for describing an air supply path of a case where outside air is compressed in compressor 5 and supplied to the fuel cell and air tank 6. The heavy line arrow indicates the supply path.

When it is determined at step S6 that the first pressure is smaller than the second pressure and is equal to or greater than the third pressure, it is considered that the pressure of the compressed air in air tank 6 does not require the replenishment but does not meet the required pressure for generating the required power as it is. In view of this, at step S9, control section 10 makes a selection to increase the compressed air in air tank 6 to the required pressure by compressor 5, and supply it to fuel cell 1.

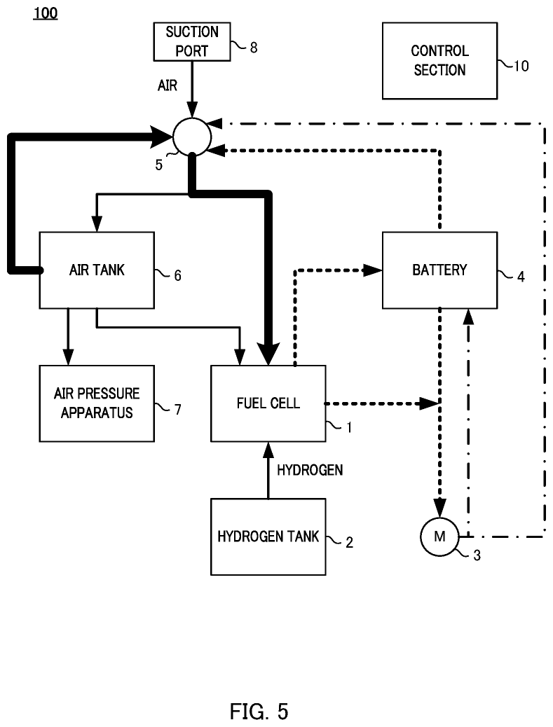

FIG. 5 is a diagram for describing an air supply path of a case where compressed air in the air tank is supplied to the fuel cell through compressor 5. The heavy line arrow indicates the supply path.

After selecting the supply source of the compressed air to fuel cell 1, control section 10 controls each section of fuel cell vehicle 100 to supply the compressed air to fuel cell 1 from the selected supply source at step S10. This control is a control of opening and closing a valve provided in an air supply pipe connecting between the components, and operating compressor 5 as necessary, for example.

The above-described control is repeatedly executed at a given interval, for example. In this manner, when the required power is changed such as when the driver changes the pressing amount of the accelerator, the second pressure can be changed at any time in accordance with the changed required power, for example.

Through the above-described control, the supply source of the compressed air for fuel cell 1 to generate power can be appropriately determined. In the case where the compressed air in air tank 6 is used for the compressed air to be supplied to fuel cell 1, it is not necessary to compress outside air by compressor 5 and supply the air, and therefore the consumption energy of fuel cell vehicle 100 can be reduced, and in turn, the fuel consumption of fuel cell vehicle 100 can be improved. In addition, in the case where the compressed air in air tank 6 is compressed by compressor 5 and supplied to fuel cell 1 when the pressure of the compressed air in air tank 6 is lower than the required pressure, the required energy can be smaller than that of the case where the outside air is compressed because the pressure of the compressed air in air tank 6 is higher than that of the outside air. In this manner, the consumption energy of fuel cell vehicle 100 can be reduced, and in turn, the fuel consumption of fuel cell vehicle 100 can be improved.

### (2) Control of Power Supply Destination Through Regenerative Power Generation

In addition, control section 10 selectively determines the supply destination of power generated through regenerative power generation of running motor 3 (hereinafter referred to as regenerated power). The control of this case is described below.

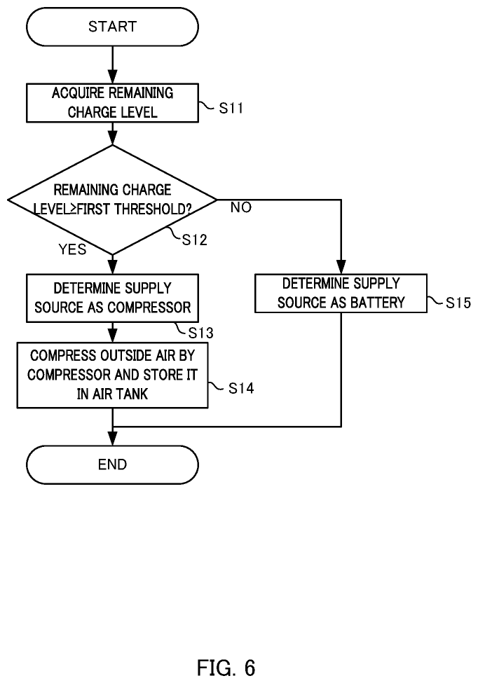

FIG. 6 is a flowchart for describing a selection control of a supply destination of a regenerated power by control section 10.

At step S11, control section 10 acquires the remaining charge level of battery 4.

At step S12, control section 10 determines whether the remaining charge level is not smaller than a predetermined first threshold value. The first threshold value is an electric energy that can sufficiently operate the electric equipment of fuel cell vehicle 100, for example. The first threshold value may be set in advance based on the power consumption amount obtained through experimental operation of fuel cell vehicle 100, for example.

When the remaining charge level is equal to or greater than the first threshold value (step S12: YES), control section 10 advances the process to step S13. When the remaining charge level is not equal to or greater than the first threshold value (step S12: NO), control section 10 advances the process to step S15.

When the remaining charge level is equal to or greater than the first threshold value, control section 10 selects the supply destination of the regenerated power to compressor 5 at step S13. Then, at step S14, control section 10 compresses the outside air taken from suction port 8 in compressor 5 and stores it in air tank 6.

On the other hand, when the remaining charge level is smaller than the first threshold value, control section 10 selects the supply destination of the regenerated power to battery 4 at step S15.

Through the above-described control, when the remaining charge level of battery 4 is sufficient and the necessity to supply the regenerated power to battery 4 is small, control section 10 can supply the regenerated power to compressor 5 so as to compress the outside air and store it in air tank 6. In this manner, it is possible to prevent a situation (invalid regeneration) where the destination of the regenerated power is lost and the regeneration is wasted. The air compressed in compressor 5 with regenerated power can be then effectively used as necessary for operating air pressure apparatus 7 and for power generation by being supplied to fuel cell 1. Thus, the efficiency of the regeneration of running motor 3 can be improved.

### Operations and Effects

As described above, fuel cell vehicle 100 according to the embodiment of the present disclosure includes fuel cell 1, air tank 6 configured to store the compressed air, and control section 10 configured to select which of the outside air and the compressed air in the air tank is to be supplied to fuel cell 1 on the basis of the first pressure, which is the pressure of the compressed air in air tank 6.

With this configuration, the supply source of the compressed air when fuel cell 1 performs the power generation can be appropriately determined. In the case where the compressed air in air tank 6 is used as the compressed air supplied to fuel cell 1, it is not necessary to compress the outside air in compressor 5 and supply it, and therefore, the consumption energy of fuel cell vehicle 100 can be reduced, and in turn, the fuel consumption of fuel cell vehicle 100 can be improved.

In addition, according to fuel cell vehicle 100 according to the embodiment of the present disclosure, when the pressure of the compressed air in air tank 6 (the first pressure) is smaller than the required pressure (the second pressure), the compressed air in air tank 6 is compressed by compressor 5 and supplied to fuel cell 1. At this time, since the pressure of the compressed air in air tank 6 is higher than that of the outside air, the required energy can be smaller than a case where the outside air is compressed and supplied to fuel cell 1. Thus, the consumption energy of fuel cell vehicle 100 can be reduced, and in turn, the fuel consumption of fuel cell vehicle 100 can be improved.

In addition, according to fuel cell vehicle 100 according to the embodiment of the present disclosure, when the remaining charge level of battery 4 is sufficient and the necessity to supply the regenerated power to battery 4 is small, control section 10 can supply the regenerated power to compressor 5 so as to compress the outside air and store it in air tank 6.

In this manner, it is possible to prevent a situation (invalid regeneration) where the destination of the regenerated power is lost and the regeneration is wasted. The air compressed in compressor 5 with regenerated power can be then effectively used as necessary for operating air pressure apparatus 7 and for power generation by being supplied to fuel cell 1. Thus, the efficiency of the regeneration can be improved.

With the above-described configuration, fuel cell vehicle 100 according to the embodiment of the present disclosure can reduce the consumption energy required for fuel cell 1 to perform power generation, and prevent energy loss due to invalid regeneration and the like. Thus, energy saving of the entire fuel cell vehicle 100 can be achieved. For example, in a large vehicle such as a truck, the energy required for the operation is considerably larger than in a passenger car, but even in such a case, the configuration of the present disclosure can suppress the energy consumption and improve the fuel consumption. In addition, unlike vehicles that run with an internal combustion, fuel cell vehicles require the power for operating an auxiliary machine for causing the fuel cell to generate power, but the configuration of the present disclosure can ensure the power required for operating the auxiliary machine.

### INDUSTRIAL APPLICABILITY

The present disclosure is suitable for fuel cell vehicles equipped with fuel cells.

1. A fuel cell vehicle comprising:
a fuel cell;
an air tank configured to store compressed air; and
a control section configured to make a selection for selecting which of outside air and the compressed air in the air tank is to be supplied to the fuel cell on a basis of a first pressure, the first pressure being a pressure of the compressed air in the air tank.

2. The fuel cell vehicle according to claim 1, wherein the control section makes the selection on a basis of a relationship between the first pressure and a second pressure, the second pressure being a pressure of the compressed air required for the fuel cell to generate a predetermined power.

3. The fuel cell vehicle according to claim 2, wherein when the first pressure is equal to or greater than the second pressure, the control section selects the compressed air in the air tank.

4. The fuel cell vehicle according to claim 2, further comprising a compressor configured to compress air,
wherein when the first pressure is smaller than the second pressure, the control section makes a selection such that the compressed air in the air tank is further compressed by the compressor and supplied to the fuel cell.

5. The fuel cell vehicle according to claim 4, wherein when the first pressure is further smaller than a predetermined third pressure smaller than the second pressure, the control section makes a selection such that the outside air is compressed by the compressor and supplied to the fuel cell.

6. The fuel cell vehicle according to claim 1, further comprising:
a running motor; and
a secondary battery,
wherein when the running motor performs regenerative power generation, the control section selects a supply destination of power obtained through the regenerative power generation on a basis of a remaining charge level of the secondary battery.

7. The fuel cell vehicle according to claim 6, wherein when the remaining charge level is smaller than a predetermined first threshold value, the control section supplies the power obtained through the regenerative power generation to the secondary battery.

8. The fuel cell vehicle according to claim 6, further comprising a compressor configured to compress air,
wherein when the remaining charge level is equal to or greater than a first threshold value, the control section compresses outside air and stores the outside air in the air tank by supplying the power obtained through the regenerative power generation to the compressor.
